(19) United States
(12) Patent Application Publication
(10) Pub. No.: US 2015/0223439 A1
(43) Pub. Date: Aug. 13, 2015

(54) Portable Rod Caddy

(71) Applicant: Jesse Caudle, Grand Junction, CO (US)

(72) Inventor: Jesse Caudle, Grand Junction, CO (US)

(21) Appl. No.: 14/177,422

(22) Filed: Feb. 11, 2014

(51) Int. Cl. A01K 97/10

(52) U.S. Cl. CPC A01K 97/10

(57) ABSTRACT

A fishing rod holder is provided. The holder comprises a one or a pair of stacked members that are made of a lightweight and conformable material, such as close-cell foam. The stacked members comprise proximal and distal ends. The proximal ends each include a plurality of cutouts along the length of the member, whereby the cutouts are shaped to provide a series of flared projections and recessions. The distal ends of the stacked members comprise a pair of attachment mechanisms. The first attachment mechanism comprises a pair of magnets that are nested between the upper and lower members of the holder, whereby each member comprises a half of the magnet that is adapted for securing onto metallic surfaces. The second attachment mechanism comprises a pair of straps that are secured through the members. The strap may comprise fasteners that enable the holder to be secured around a support surface.

### CROSS REFERENCE TO RELATED APPLICATION

This application claims the benefit of U.S. Provisional Application No. 61/833,243 filed on Jun. 10, 2013, entitled “Portable Rod Caddy.” The above identified patent application is herein incorporated by reference in its entirety to provide continuity of disclosure.

### BACKGROUND OF THE INVENTION

1. Field of the Invention

The present invention relates to fishing rod holders. More specifically the invention relates to a fishing rod holder that is configured to hold a plurality of rods therein when secured onto a support surface.

Fishing rod support devices are of use to fisherman who desire a place to support their fishing rods. The holders may be adapted for use in the home, on boats, in cars, or as stand-alone devices that can be used while fishing. These supports may comprise an individual holding case or may provide a device having a plurality of holders that are adapted for holding one or more fishing rods therein. Some supports may be permanently secured to a wall or other structure, and others can be made of lightweight materials, thereby enabling portability.

The drawbacks of traditional fishing rod holders is that they utilized for supporting fishing rods on certain surfaces. A fishing rod holder that is adapted for use in a home dwelling is not suitable for use outdoors, and a holder that is adapted for securement onto an automobile is not utilized for indoor use or for use outside. As such, there is a desire for a fishing rod holder that is adapted for secure a plurality of rods therein, whereby the rod holder is adapted to secure on a variety of support surfaces.

The present invention, however, provides a fishing rod holder that is adapted for securement onto a variety of surfaces. The rod holder comprises a plurality of cutouts for the reception of a plurality of fishing rods. The holder further comprises a pair of attachment mechanisms. The first attachment mechanism comprises a pair of magnets that are adapted for securing the holder against metallic objects, such as on an automobile. The second attachment mechanism comprises a pair of straps that are adapted for securing around an object, such as the branch of a tree. The combination of the attachment mechanisms enables the rod holder to vertically support a plurality of rods on a variety of devices, thereby providing convenience in a variety of locations.

2. Description of the Prior Art

Devices have been disclosed in the prior art that relate to fishing rod holders. These include devices that have been patented and published in patent application publications. These devices generally relate to holders that are adapted for vertically securing a fishing rod on a singular support surface. The following is a list of devices deemed most relevant to the present disclosure, which are herein described for the purposes of highlighting and differentiating the unique aspects of the present invention, and further highlighting the drawbacks existing in the prior art.

One such prior art device, U.S. Pat. No. 5,678,700 to Crosson, Jr. discloses a reel and rod hanger. The hanger is adapted for holding rods and reels in an upright orientation. The hanger comprises a bracket having a pair of opposing side walls, a back wall, and upper and lower surfaces. Each of the upper and lower surfaces comprises a plurality of corresponding cutouts, whereby the cutouts are adapted for retaining the rods and reels therein. Further, the prior art device is designed for elevated securement on a wall. The prior art device, however, fails to provide a means for attachment onto metallic devices by magnets, such as on the sides of a car.

Another prior art device, U.S. Pat. No. 7,503,459 to Grayson provides a tool for storing fishing rods and other sports equipment. The device comprises a housing that comprises at least one opening thereon. The opening is formed by a U-shaped channel with a plurality of opposing jaws along the length of the channel. Each of the jaws are biased closed and an elongate object may be pressed into the U-shaped channel, thereby opening the jaws and allowing access to the interior area of the U-shaped channel. The fishing rod may be secured within the jaws and the bottom of the rod may be vertically supported by a second, lower, support surface. The device further comprises securing screws that are adapted for securing the device onto a fixed surface. The prior art device of Grayson, however, fails to provide a means for non-permanent securement on to different support surfaces.

U.S. Pat. No. 5,588,542 to Winkler, Jr. provides a fishing rod rack that is adapted for supporting a fishing rod on a support surface. The device comprises upper and lower assemblies that are vertically separated from one another, whereby the upper assembly is adapted for receiving and upper end of a fishing rod and the lower assembly is adapted for receiving the lower end of a rod. The upper assembly comprises a plurality of apertures thereon for the reception of a rod, whereby the upper assembly comprises a two part design that hingedly opens to enable the placement of the rod within the apertures. The prior art device, however, fails to provide magnets or attachment straps that are adapted for securing the device onto a support surface.

Yet another prior art device, U.S. Pat. No. 6,360,902 to Searles provides a storage system for fishing poles, whereby the system is designed for placement on a boat deck. The device is adapted for holding a plurality of fishing poles in an upright orientation. The device comprises upper and lower surfaces that are connected to each other by opposing side walls, whereby the lower surface is adapted for supporting a butt end of a fishing pole thereon and the upper surface comprises notches that are adapted for receiving the fishing pole. The device, however, fails to provide a means for attaching the fishing pole holder onto a vertically oriented support surface.

Finally, U.S. Pat. No. 4,582,203 to Davis provides a fishing rod holder that is adapted for securement onto a boat. The holder comprises upper and second separated support surfaces. The upper support surface comprises a plurality of U-shaped recessions thereon along the length of the support surface. The lower support surface comprises a singular elongate rod with multiple curvatures that form a plurality of recessions thereon. The separated surfaces comprise a means for securing the surfaces onto a small boat in a horizontal orientation, thereby facilitating easy access to the fishing poles. The prior art device, however, fails to provide a strap or magnetic means for securing the device onto a support surface, such as a tree.

The present invention, however, provides a fishing rod holder that is adapted for securement onto a variety of objects. The fishing rod holder comprises a pair of upper and lower stacked planer support members. The upper support member comprises a plurality of cutouts that are offset from the cutouts of the lower member, thereby providing overlapping and open spaces between the stacked members. The present invention further comprises a pair of securing mechanisms. A first securement mechanism comprises a pair of lengthwise opposed magnets that are recessed between the upper and lower planar members. These securing mechanisms enable the device to be secured onto the sides of vehicle or another suitable metallic object. The second securing mechanism comprises a pair of opposed flexible attachment straps. The straps each include hook and loop fasteners. In use, the present invention is capable of securing onto an automobile, or alternatively, the straps of the device may wrap around a tree limb or another horizontal support surface if desired.

In view of the drawbacks of the prior art devices, it is shown that the prior art has several known setbacks and that the present invention is substantially divergent in design elements from the prior art and subsequently it is clear that there is a need in the art for an improvement to existing fishing pole support devices. In this regard the instant invention substantially fulfills these needs.

### SUMMARY OF THE INVENTION

In view of the foregoing disadvantages inherent in the known types of fishing pole holders now present in the prior art, the present invention provides a new holder wherein the same can be utilized for providing convenience for the user when desiring the option of supporting the fishing pole holder on different surfaces.

It is therefore an object of the present invention to provide a new and improved fishing rod holding and support device that has all of the advantages of the prior art and none of the disadvantages.

It is another object of the present invention to provide a fishing rod holder having at least one planar member or a plurality of offset upper and lower planar members forming a support for fishing rods thereagainst.

Another object of the present invention is to provide a fishing rod holder having a plurality of cutouts that are adapted for retaining fishing rods therebetween.

Yet another object of the present invention is to provide a fishing rod holder comprising magnetic and strap attachment means that are adapted for supporting the holder on metallic objects or around horizontal supports.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays a perspective view of the fishing rod holder of the present invention.

FIG. 2A displays a reverse-perspective view of the fishing rod holder of the present invention.

FIG. 2B displays a perspective view of an alternative configuration of the fishing rod holder of the present invention.

FIG. 3 displays a view of the fishing rod holder in use, whereby the holder is secured onto the side of an automobile.

FIG. 4 displays a close-up view of the rod holder in use while secured onto the side of an automobile.

FIG. 5 displays a view of the fishing rod holder in use, whereby the holder is secured onto a limb of a tree.

### DETAILED DESCRIPTION OF THE INVENTION

Reference is made herein to the attached drawings. Like reference numerals are used throughout the drawings to depict like or similar elements of the fishing rod holder. For the purposes of presenting a brief and clear description of the present invention, the preferred embodiment will be discussed as used for providing a lightweight and portable fishing rod holder that is designed to be supported on a variety of surfaces and objects. The figures are intended for representative purposes only and should not be considered to be limiting in any respect.

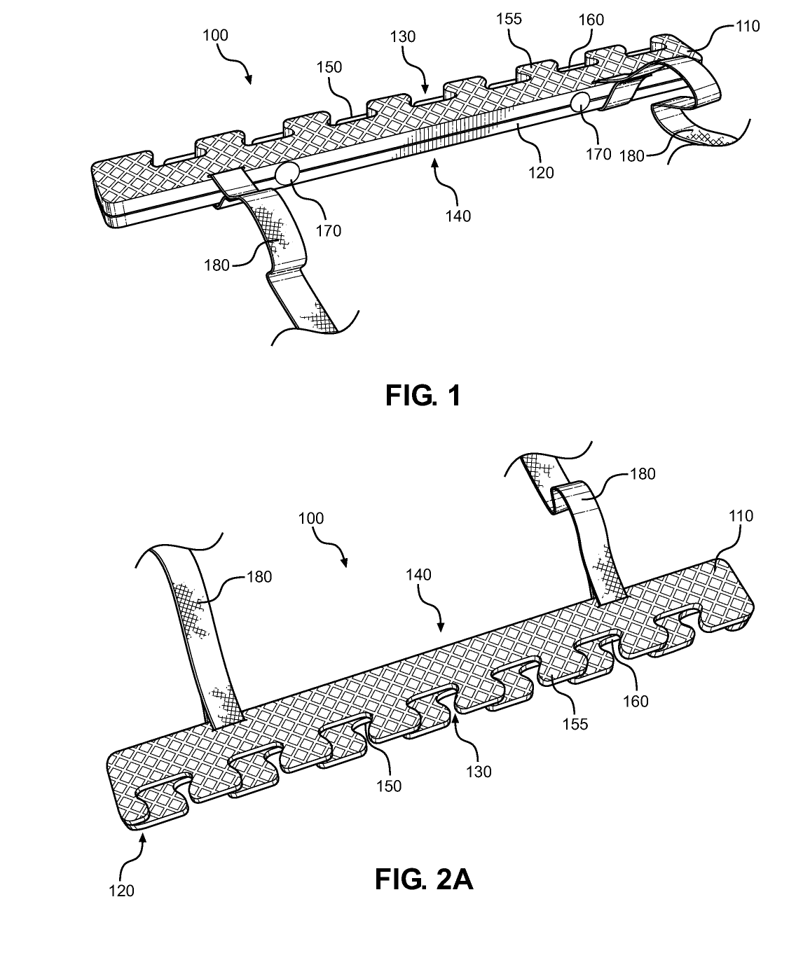

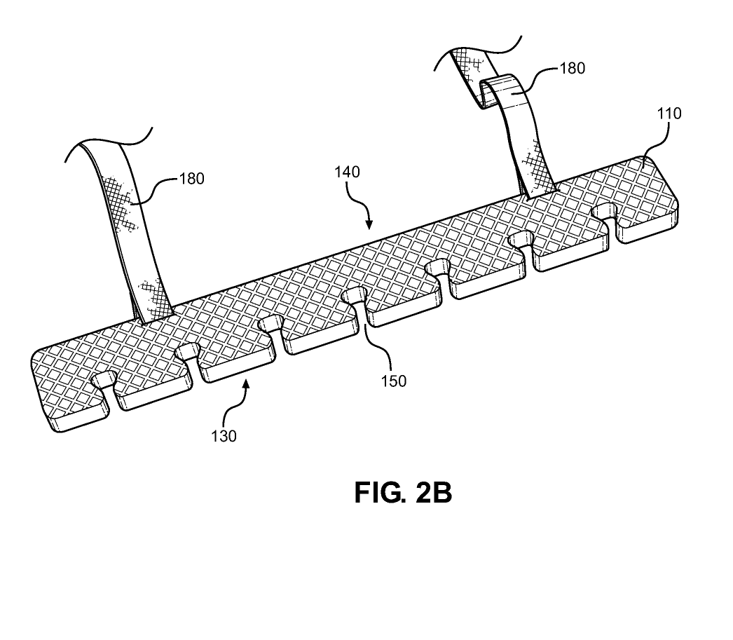

Referring now to FIGS. 1 and 2A, there is shown a perspective view of the fishing rod holder 100 and a reverse view of the present invention. The fishing rod holder is portable, and is comprised of lightweight materials, such as a durable foam material. The fishing rod holder is comprised of at least one elongate planar member, a pair of magnets 170, and a pair of support straps 180. The elongate planar members 110, 120 each comprise a proximal end 130, a distal end 140, and outer ends forming a substantially rectangular member. The outer ends are generally shorter than the proximal 130 and distal ends 140 to form the rectangular shape. The proximal end 130 of the members comprise a plurality of cutouts 150 along the length thereof. The cutouts 150 provide a plurality of recessions 160 and flared projections 155 along the length thereof adapted to support fishing rods therein.

In one embodiment, the present invention is comprised of an upper planar member 110 and a lower planar member 120 that function in conjunction to one another to support fishing rods from the proximal ends 130 thereof. This configuration is shown in FIGS. 1 and 2A. The distal end 140 of the upper 110 and lower planar 120 members comprise fishing rod holder attachment mechanisms. The first attachment mechanism comprises a pair of magnets 170 that are separated along the length of the distal end 140 of the planar members. The magnets 170 are located between, and recessed within the upper 110 and lower 120 planar members and facilitate the attachment of the fishing rod holder onto a metallic object, such as an automobile. The second attachment mechanism comprises a pair of flexible attachment straps 180, such as those made from nylon. The attachment straps 180 are located along the length of the planar members and secure through slots along the distal end 140 thereof such that the straps 180 are substantially perpendicularly disposed with respect to the planar member length. A user may wrap the attachment straps around a suitably sized object, such as the limb of a tree. Thereafter, the strap 180 can be attached back onto itself by hook and loop fasteners, wrapped through a retaining ring, or a combination of the two.

Referring again to FIG. 2A, there is displayed a reverse view of the fishing rod holder of the present invention. The holder 100 comprises upper 110 and lower 120 planar members, whereby the members are in constant contact and are stacked on top of each other. Additionally, the cutouts 150 of the upper member 110 are offset from the cutouts of the lower member 120. The offset cutouts 150 of the upper and lower members provide an overlap and a slight opening between the two members, which enables elongated rods to be secured therein.

Referring now to FIG. 2B, there is shown an embodiment of the present invention in which a singular planar member 110 is shown. The singular planar member 110 includes a distal 140 and proximal 130 end, wherein the cutouts 150 are formed therein along the proximal end 130 and without a separate member 110. The cutouts 150 are adapted to conform to the profile of a fishing rod and secure the same therein. As with the embodiment of FIG. 2A, the single member embodiment includes an attachment strap 180 and distal end 140 magnets for securing the assembly to a support or to a metallic surface, respectively.

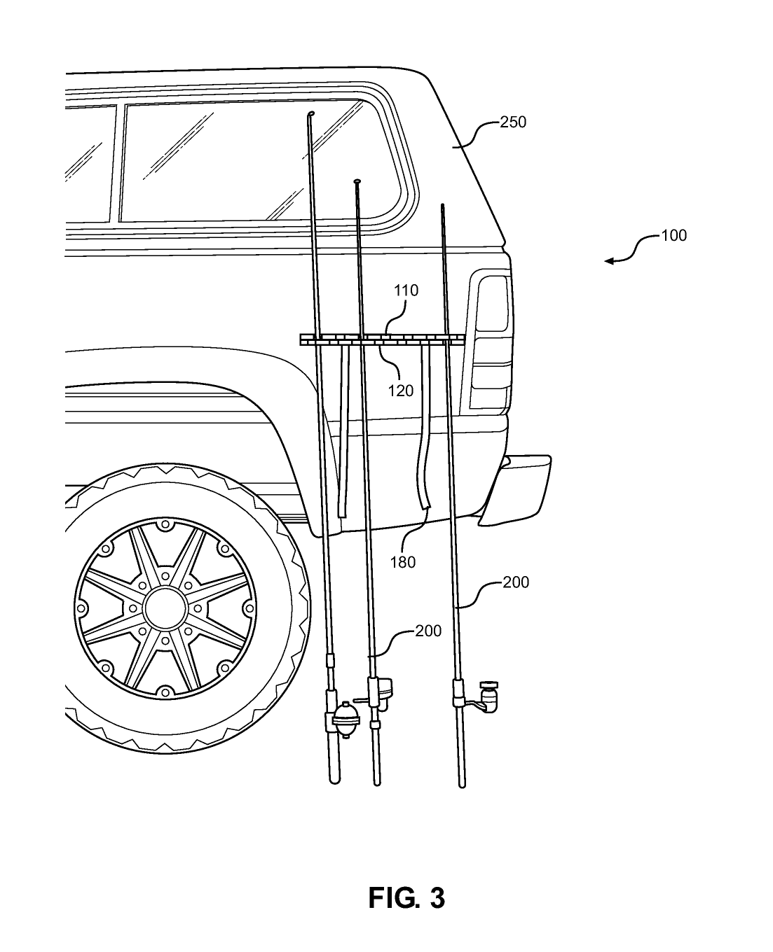

Referring now to FIG. 3, there is displayed a view of the fishing rod holder in use, whereby the holder 100 is secured onto the side of an automobile 250. The distal ends 140 of the upper 110 and lower 120 planar members comprise a pair of recessed magnets 170. These magnets are designed to adhere onto a variety of metallic objects, including that of an automobile 250. A user may secure fishing rod holder 100 onto the side of an automobile, thereafter the user may insert one or more rods 200 into the holder 100.

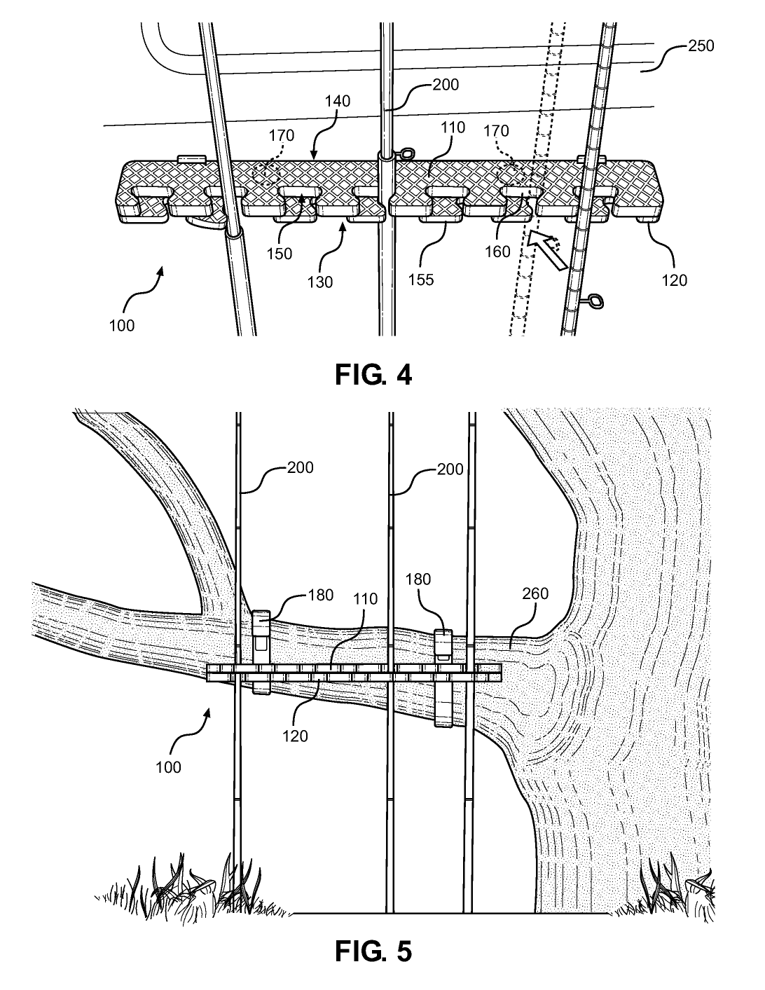

FIG. 4 displays a close-up view of the fishing rod holder 100 secured onto the side of an automobile 250. The fishing rod holder 100 comprises a pair of magnets 170 that are utilized for securing the holder onto the automobile. Additionally, FIG. 4 displays the steps of securing fishing rods 200 within the holder 100. The entirety of the fishing rod holder 100 is made of a lightweight, and durable foam material. The cutouts 150 of the proximal end 130 of the two offset members provides a recessed area 160 and a flared projection 155 from the recession. The offset members further provide an overlapping portion and a slight opening between the upper and lower members. A user may push a fishing rod 200 into the slight opening formed by the offset members. The foam material of the holder flexes when in contact with an outside force, thereby enabling placement of the rod into the recessed area of the cutout. Thereafter, the flared projection 155 resumes its prior positioning and recloses the opening formed while inserting fishing rod.

As shown in FIG. 5, the holder 100 can also be secured onto the limb of a tree 260. In addition to the magnetic attachment means, the fishing rod holder of the present invention also comprises a pair of attachment straps 180 that are adapted to secure around supporting objects, such as around the limb of a tree. The strap 180 includes separable ends that can be secured together around a suitable support. The strap is secured through the planar members and includes a strap end fastener for securing the strap ends to themselves. The fastener may be snaps, buttons, hook and loop fasteners, retainer rings, and other suitable fasteners. These fasteners enable each of the two straps 180 to be separately secured onto an object, thereby providing a secure fitting onto variable diameter sized objects.

The present invention provides a lightweight fishing rod holder 100 that can be secured onto a variety of objects, thereby providing convenience when used outdoors. The holder comprises a pair of stacked planar members that provide the body of the holder. Each of the members comprise a plurality of proximal cutouts 150 that form a recessed portion 160 and a flared projection 155. Additionally, the cutouts 150 of the upper 110 and lower 120 stacked members slightly offset from one another, thereby providing overlapping and opened spaces between the two members. During use, a user may press a fishing rod 200 into the slight opening between the upper and lower members. The flared projections of the cutouts will flex outward a small amount, thereby enabling the user to place the rod into the cutout recession. Thereafter, the projections resume their prior orientation and secure the rod within the cutouts of the rod holder.

The fishing rod holder includes two types of attachment mechanisms. The first attachment mechanism comprises a pair of magnets 170 that are recessed between the lengthwise ends of the upper 110 and lower 120 planar members. These attachment means facilitate the attachment of the holder onto metallic objects, such as the side of an automobile. Additionally, the device comprises a pair of flexible attachment straps 180 that are located on opposing ends of the upper planar member. The straps 180 may comprise a fastener that enables the flexible strap to easily wrap around horizontal supports. For example, the straps may be utilized to wrap around the limb of a tree 260, which is of convenience when a user is fishing in undeveloped areas, or may be secured onto the side of a car 250 if suitable trees are not present.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing rod holder, comprising;
at least one elongate planar member having a proximal end, a distal end, a length, and outer ends forming a substantially rectangular member;
said at least one planar member comprising a plurality of cutouts on said proximal end of said upper elongate planar member;
said cutouts of said at least one elongate planar member comprising a recession and a flared projection adapted to accept and secure a fishing rod therein;
and whereby said flared projections are flexible when a fishing rod is placed therein, thereby enabling a fishing rod or similar shaped object to be secured within said cutouts;
said distal end of said cutouts of said at least one elongate planar member further comprising a first securement mechanism and a second securement mechanism;
said first securement mechanism comprising at least one magnets that is located along the length of said distal end;
said second securement mechanism comprising a pair of attachment straps extending perpendicular with respect to said length of said least one elongate planar member.

2. The fishing rod holder of claim 1, wherein said at least one elongate planar member further comprises:
an upper elongate planar member and a lower elongate member;
whereby said upper elongate planar member is connected to and secured on top of said lower elongate planar member;
said upper and lower planar members having a proximal end and a distal end;
said upper elongate planar member comprising a plurality of cutouts on said proximal end of said upper elongate planar member;
said lower elongate planar member comprising a plurality of cutouts on said proximal end of said upper elongate planar member;
said cutouts of said upper and lower planar members being adapted to provide a recession and a flared projection on said proximal ends of said upper and lower planar members;
and whereby said cutouts of said upper planar member are offset from said cutouts of said lower planar member, thereby providing offset flared projections and recessions.

3. The fishing rod holder of claim 2, wherein said magnets are further located between, and recessed within said upper and lower planar members, thereby facilitating the attachment of upper planar member and lower planar member to a metallic support.

4. The fishing rod holder of claim 1, wherein said attachment straps comprise separable ends and a strap end attachment means that is adapted for securing said separable ends together when wrapped around a support.

5. The fishing rod holder of claim 4, wherein said strap end attachment means comprise one or more of hook and loop fasteners and a retaining ring.

6. The fishing rod holder of claim 1, wherein said attachment straps are attached through a slot in each planar member and said attachment straps extend perpendicularly with respect to each planar member length.
